(19) United States
(12) Patent Application Publication
(10) Pub. No.: US 2023/0347377 A1
(43) Pub. Date: Nov. 2, 2023

(54) METERING DEVICE AND METHOD FOR THE METERED DISCHARGE OF A MEDIUM

(71) Applicant: BDTRONIC GMBH, Weikersheim (DE)

(72) Inventors: André Hellinger, Bad Mergentheim (DE); Manuel Kunz, Röttingen (DE); Benedikt Ledwig, Weikersheim (DE)

(73) Assignee: BDTRONIC GMBH, Weikersheim (DE)

(21) Appl. No.: 17/793,982

(22) PCT Filed: Dec. 17, 2020
(86) PCT No.: PCT/EP2020/086879

§ 371 Date: Jul. 20, 2022

(30) Foreign Application Priority Data
Jan. 24, 2020 (DE) 10 2020 000 412.1

(51) Int. Cl. B05D 1/26; B05C 11/00; G01F 15/00

(52) U.S. Cl. CPC B05D 1/26; B05C 11/00; G01F 15/00

(57) ABSTRACT

In providing a metered discharge of a medium to a metering object moving relative to the metering means, collisions can occur between the metering means and the metering object. Such a collision results in an incorrectly metered discharge of the medium, making the metering object unusable. The invention provides a metering device and a method for the metered discharge of a medium, with which the metered discharge of a medium can be monitored. This is achieved by a metering means being coupled to at least one sensor, via which a collision between the metering means and a metering object can be detected.

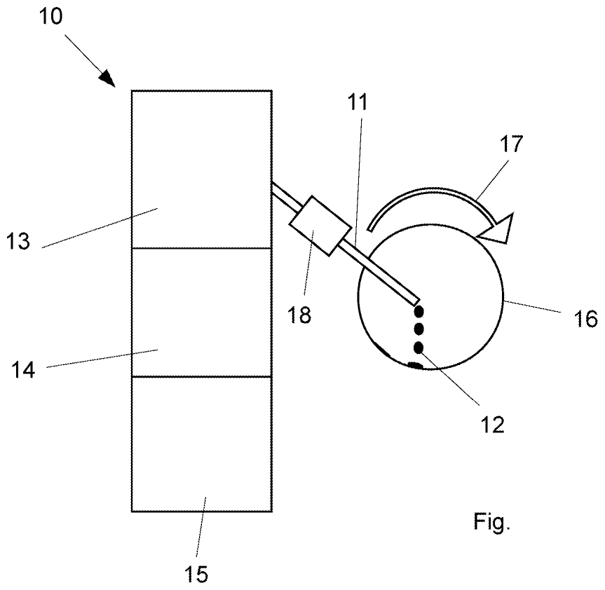

### CROSS REFERENCE TO RELATED APPLICATIONS

This application is the US national phase of and claims the benefit of and priority on International Application No. PCT/EP2020/086879 having an international filing date of 17 Dec. 2020, which claims priority on and the benefit of German Patent Application No. 10 2020 000 412.1 having a filing date of 24 Jan. 2020.

### BACKGROUND OF THE INVENTION

### Technical Field

The invention relates to a metering method for the metered discharge of a medium, in particular for the metered impregnation of a metering object, having a metering means, via which the medium can be applied to a metering object, wherein the metering object moves relative to the metering means during the discharge of the medium. Furthermore, the invention relates to a method for the metered discharge of a medium, in particular for the metered impregnation of a metering object, having a metering means via which the medium can be applied to a metering object, wherein the metering object moves relative to the metering means during the discharge of the medium.

### Prior Art

In the metered discharge of a fluid or fluidized medium, the medium is fed to a metering object at a predetermined discharge rate or volume flow rate or cycle rate. For example, the medium to be metered can be a means of impregnating objects. For example, it is known that electronic components or electric motors are impregnated with a suitable medium, such as a resin, during production. For this purpose, for example, a motor stator is arranged such that it rotates on an axis and is impregnated by successively applying a resin to it using a metering means of the metering device. The relative rotation of the metering means and the stator allows the impregnation to be carried out in a particularly simple and efficient way. In addition to this specific example, other applications for a metering device of the type described here are also conceivable.

In the metered discharge of a medium to a metering object moving relative to the metering means, different sources of error can lead to collisions between the metering means and the metering object or other elements, such as protruding cables of this metering object or a machine frame, etc. A collision of this type with the metering means, which is usually a metering needle or a metering tube, results in an incorrectly metered discharge of the medium, making the metering object unusable in most cases. Since the metering process is not monitored individually, in particular in the industrial application of such metering devices, such collisions go unnoticed. It may only be noticed at the end of the process that a collision between the metering means and the metering object has occurred and that the medium has thus been applied in an uncontrolled manner. As a result, the device must be cleaned and readjusted, and a considerable number of metering objects may have been incorrectly manufactured.

### BRIEF SUMMARY OF THE INVENTION

The object of the invention is to create a metering device and a method for the metered discharge of a medium, with which the metered discharge of a medium can be monitored.

The above object is achieved by a metering device for the metered discharge of a fluid or fluidized medium, in particular for the metered impregnation of a metering object, having a metering means, via which the medium can be applied to a metering object, wherein the metering object moves relative to the metering means during the discharge of the medium, characterized in that the metering means is coupled to at least one sensor, via which a collision between the metering means and the metering object can be detected. As soon as a collision between the objects moving relative to each other has been detected, appropriate counter-measures can be initiated, so that the economic damage can be kept to a minimum. If no collision is detected during the metering process, it can be assumed that the metered discharge of the medium has taken place without errors.

It may also be preferable for the sensor to be designed as a strain gauge, a piezo-element, an antenna, a capacitive, inductive or galvanic contact element, as an optical sensor, an opto-electric sensor, as a mechanical touch sensor or similar. It is conceivable that the at least one sensor is either directly or indirectly connected, in particular coupled, to the metering means, preferably a metering needle or a metering tube, a holder of the metering means or in a housing on the metering means. For example, by using a piezo-element as a sensor, shocks and/or vibrations between the metering needle holder and a carrier element can be detected. In the event of a collision, due to the force applied to the needle the force can be transferred to the piezo-element so as to generate a measurable voltage, which can then be evaluated by a control unit or measuring device. To record such shocks or vibrations, it is also advisable to install a strain gauge along the metering needle. In the event of a collision between the needle and the metering object, the metering needle and the strain gauge deform, so that a varying electrical resistance can be measured along the measuring gauge. The nature or size of the varying resistance can also be used to infer information about the nature and severity of the collision. In addition, the metering needle can be designed as an antenna that can be coupled to a simple electrical oscillator circuit. If the metering object or the collision object approaches the needle, the impedance and the natural frequency of the oscillator circuit will change. Such a change in the antenna property can also allow a collision to be detected or predicted. Likewise, optical sensors or mechanical touch sensors can be connected to the metering needle to detect collisions.

It is also preferably provided that the at least one sensor is connected to a measuring device with which specific sensor signals can be detected or suppressed, wherein a collision between the metering means and the metering object can be detected or predicted on the basis of the captured sensor signal. In the event of a collision or in the event of an imminent collision, the measuring device or the control unit can issue an error message which interrupts the production or metering process. By evaluating the captured sensor signals, for example, different collisions can be categorized. For example, a collision with a machine frame or a cable may have a different signal signature than a collision with the metering object. It is conceivable that various signal processing algorithms, preferably also frequency filters, are stored in the measuring device or control unit for such an analysis or evaluation of the signals.

A particularly advantageous exemplary embodiment of the present invention may provide that, in order to detect a structure-borne sound that occurs in the event of a collision between the metering means and the metering object, the sensor is designed as a microphone. As soon as a structure-borne sound with a corresponding signal structure to be evaluated is detected by the microphone, a corresponding error message or warning signal can be output to the control unit in order to interrupt the metering process, for example.

In particular, it is also conceivable that at least one pass filter, preferably a high-pass filter, is assigned to the microphone for analyzing the collision and/or filtering frequencies generated in the event of a collision. It has been found that the structure-borne sound due to a collision between the metering needle and the metering object or a motor stator has a very specific frequency signature. As soon as such a specific signal signature is measured, counter-measures can be initiated. This allows faulty production of the metering objects or the motor stators to be detected and avoided at an early stage.

The invention may also provide that, in the event of a collision being detected between the metering unit and the metering object, the relative motion between the metering unit and the metering object is interrupted by a control unit. In the industrial application of such metering devices, a number of processes run in parallel or simultaneously. This means that it is not necessary to interrupt the entire metering process of a plurality of metering objects, but only the metering process for which a collision has been detected. As soon as the error message or fault has been detected and corrected, the metering process can continue.

An advantageous refinement of the present invention can provide that a plurality of metering means each have at least one sensor, which can be read out in parallel and the measured values of which can be analyzed and compared in parallel. This can eliminate false signals, for example. If, for example, all sensors are subjected to a shock at the same time, it can be assumed that this does not involve a collision of all metering needles, but probably a collision with the entire machine frame.

A further exemplary embodiment of the invention can provide that the measuring device and/or the control unit is/are connected to, preferably equipped with, an artificial neural network (ANN) to detect the nature of the collision on the basis of the acquired sensor signals, wherein the ANN can be trained in particular using the acquired sensor signals in order to anticipate various collisions, detect them and implement appropriate counter-measures. It is conceivable in this case that the ANN or an artificial intelligence system (AI system) can detect certain patterns in the sensor signals or signal signatures and use these patterns to recognize the type of collision. The ANN or the AI system can be trained or improved in advance, either using sample data that must be labeled according to the application, or during operation of the device. When labeling the data, for example, “bad” signals can be distinguished from “good” signal signatures, i.e., whether there is a risk of collision or not, and can be recognized later as such by the AI. This machine learning of the device allows the process to be monitored even more efficiently and autonomously.

A method for achieving the above-mentioned object is described by a method for the metered discharge of a fluid or fluidized medium, in particular for the metered impregnation of a metering object, having a metering means via which the medium can be applied to a metering object, wherein the metering object moves relative to the metering means during the discharge of the medium, characterized in that by means of at least one sensor as disclosed herein, a collision between the metering means and the metering object is detected. By the early detection of a collision or an imminent collision, the metering process can be interrupted and the faulty production of the metering objects can be avoided.

Furthermore, it can be provided according to the invention that the structure-borne sound that occurs during a collision is captured and analyzed by means of a microphone arranged on a metering means. Depending on the structure-borne sound, appropriate measures are initiated by a control unit or a measuring device, such as a stopping the metering or the metering process, or regulating a metering flow.

In addition, a particularly advantageous refinement of the present invention may provide that the metering flow of the metering means is monitored by the microphone, in particular by another, additional sensor, and if necessary regulated via a control unit. This allows greater process reliability to be achieved. If, for example, a failure of the material flow occurs, e.g., due to a defective pump or hose, the controller issues an error message and stops production. Ideally, not only is the throughput checked for the presence of a metering flow, but also the flow is measured in terms of its volume per unit time. To implement this, it may be possible to manipulate the material flow, e.g., by inserting screens or baffles, in order to add a turbulent component to the laminar flow, which could be detected with a microphone, for example.

In addition, it is conceivable for the acquired sensor signals to be processed by an artificial neural network (ANN) in order to detect the type of collision on the basis of the acquired sensor signals, wherein the ANN is trained in particular using the acquired sensor signals, in order to predict and detect various collisions and to initiate appropriate counter-measures. It is possible in this case that an artificial intelligence system (AI system) or the ANN can detect certain patterns in the sensor signals or signal signatures and use these patterns to recognize the type of collision. The ANN or the AI system must be trained in advance for this purpose, either using sample data that must be labeled according to the application, or during operation of the device. In addition, the system can be continuously improved. When labeling the data, for example, “bad” signal signatures are distinguished from “good” signal signatures and later recognized by the AI as such. This machine learning of the device allows the process to be monitored even more efficiently and autonomously. For a more detailed description of an ANN or an AI system, reference should be made to the relevant literature.

### BRIEF DESCRIPTION OF THE DRAWING

A preferred exemplary embodiment of the present invention is described in more detail below using the single figure of the drawing.

### DETAILED DESCRIPTION OF PREFERRED EMBODIMENTS

The figure shows a highly schematic view of a possible exemplary embodiment of a metering device 10 according to the invention. The metering device 10 shown in the figure comprises a metering means 11 for the metered discharge of a medium 12. In addition, the metering device 10 can have a support 13 or an actuator for the targeted movement of the metering means 11, a system controller 14, and a measuring and/or evaluation unit 15. In addition, the highly schematic metering device 10 here can also have fewer or more components or be connected to other components that are necessary for the operation of the metering means 11. Furthermore, it may be provided that, in the case of a preferred exemplary embodiment of the invention, a plurality of such metering means 11 can be operated or controlled in parallel.

The metering means 11 shown in the figure is designed, for example, as a metering needle or metering tube. In addition, other forms or embodiments of the metering means 11 are conceivable. The tubular metering means 11 is used to apply the medium 12 to a metering object 16. In order to apply this medium 12 to a predetermined surface of the metering object 16, the metering object 16 can be moved relative to the metering means 11. In the exemplary embodiment shown in the figure, the metering object 16 rotates about a concentric axis in a relative motion 17 with respect to the metering means 11. The metering object 16 can be, for example, a stator of a motor which is to be impregnated on an inner side with an impregnating means, such as a resin. In order to apply the medium 12 or the resin to the entire inner surface of the stator or the metering object 16, the stator can move relative to the metering means 11 in accordance with the relative motion 17, parallel to a rotational axis of the metering object 16.

According to the invention, the metering means 11 shown is connected to a sensor 18. This sensor can be, for example, a strain gauge, a piezo-element, an antenna, a capacitive, inductive or galvanic contact element, an optical sensor, an opto-electric sensor, a mechanical touch sensor, or an acoustic sensor or microphone. According to the specific mode of operation of the sensor 18, it may be connected to the metering means 11. For example, it can be provided that a strain gauge is attached along the shaft-like metering means 11. Alternatively or in addition, it is conceivable for the entire metering means 11, which can be of metallic construction, to be designed as an antenna for an oscillator circuit. In the case that the sensor 18 is a microphone, it is provided that the sensitive side of the microphone is arranged directly on the metering means 11. For the exemplary embodiment in which the sensor 18 is designed as an optical sensor, it is conceivable also for a reflective element to be arranged on the metering means 11.

As soon as a movement of the metering means 11 is detected by the sensor 18 during operation of the metering device 10, this can indicate a collision between the metering means 11 and the metering object 16, which is unintended or to be avoided. As soon as the system controller 14 or evaluation unit 15 reading the sensor 18 receives an appropriate specific sensor signal, a warning signal can be generated or a corresponding counter-measure can be initiated, such as suspending the metering process. The evaluation unit 15 not only detects that the sensor 18 has detected a collision between the metering means 11 and the metering object 16, but in fact also analyzes the precise measuring signal. In this way, certain signal structures or signatures can indicate certain events. For example, the signal induced by the collision of the metering means with the metering object 16 can have a different structure, such as a collision of the metering means 11 with a machine frame or a cable of the metering object 16. In particular, a structure-borne sound that is produced in such collisions has different frequency structures depending on the object or collision. This structure-borne sound is captured by the microphone and analyzed accordingly by the evaluation unit 15. For this purpose, it is conceivable that different pass filters are assigned to the evaluation unit 15. In the system controller 14 or the evaluation unit 15, sensor-specific signal structures can be stored for various sensors 18, which have been captured and stored in advance as patterns for various collision events.

The sensor 18, in particular the microphone, not only allows the metering process to be monitored for a possible collision, but also monitors the flow of the medium 12 through the metering means 11 itself. The flow of the medium 12 through the metering means 11 generates a specific frequency signature which can be measured by the microphone. As soon as this signature changes, this can be used as an indicator that the through-flow of the medium 12, and thus the metering process, is faulty. If such a process fault is detected, the system controller 14 can again initiate appropriate counter-measures.

It should be explicitly pointed out that the invention described here is not intended to be restricted to the exemplary embodiment shown in the figure, but rather can be used equally well in other domains.

### LIST OF REFERENCE SIGNS

10 metering device
11 metering means
12 medium
13 support
14 system controller
15 evaluation unit
16 metering object
17 relative motion
18 sensor

1. A metering device (10) for the metered discharge of a fluid or fluidized medium (12), in particular for the metered impregnation of a metering object (16), having a metering means (11), via which the medium (12) can be applied to a metering object (16), wherein the metering object (16) moves relative to the metering means (11) during the discharge of the medium (12), and wherein the metering means (11) is coupled to at least one sensor (18), via which a collision between the metering means (11) and the metering object (16) can be detected.

2. The metering device (10) as claimed in claim 1, wherein the sensor (18) is selected from the group consisting of a strain gauge, a piezo-element, an antenna, a capacitive element, an inductive element, a galvanic contact element, as an optical sensor, an opto-electric sensor, and a mechanical touch sensor.

3. The metering device (10) as claimed in claim 1, wherein the at least one sensor (18) is connected, in particular coupled, directly or indirectly to the metering means (11), preferably a metering needle or a metering tube, a holder of the metering means (11) or in a housing on the metering means (11).

4. The metering device (10) as claimed in claim 1, wherein the at least one sensor (18) is connected to a measuring device (15) with which specific sensor signals can be detected or suppressed, wherein on the basis of the captured sensor signal a collision between the metering means (11) and the metering object (16) can be detected.

5. The metering device (10) as claimed in claim 1, wherein the sensor (18) is designed as a microphone for detecting a structure-borne sound which occurs during the collision between the metering means (11) and the metering object (16).

6. The metering device (10) as claimed in claim 5, wherein at least one pass filter, preferably a high-pass filter, is assigned to the microphone, for analyzing the collision and/or filtering frequencies that are generated in the event of a collision.

7. The metering device (10) as claimed in claim 1, wherein in the event of a collision being detected between the metering means (11) and the metering object (16), the relative movement between the metering means (11) and the metering object (16) can be suspended by means of a control unit (14).

8. The metering device (10) as claimed in claim 1, further comprising a plurality of the metering means (11) each have at least one sensor (18), which can be read out in parallel and the measured values of which can be analyzed and compared in parallel.

9. The metering device (10) as claimed in claim 1, wherein the measuring device (15) and/or the control unit (14) is/are connected to, preferably equipped with, an artificial neural network (ANN) to detect the nature of the collision on the basis of the acquired sensor signals, wherein the ANN can be trained in particular using the acquired sensor signals, in order to anticipate various collisions, detect them and implement appropriate counter-measures.

10. A method for the metered discharge of a fluid or fluidized medium (12), in particular for the metered impregnation of a metering object (16), having a metering means (11) via which the medium (12) can be applied to a metering object (16), wherein the metering object (16) moves relative to the metering means (11) during the discharge of the medium (12), wherein via at least one sensor (18), a collision between the metering means (11) and the metering object (16) is detected.

11. The method as claimed in claim 10, wherein by means of a microphone which is arranged on the metering means (11), the structure-borne sound occurring in a collision is captured and analyzed.

12. The method as claimed in claim 11, wherein, depending on the detected structure-borne sound, measures are initiated by a control unit (14), such as stopping the metering or the metering process, or regulating a metering flow.

13. The method as claimed in claim 11, wherein by means of the microphone, in particular by means of another or additional sensor (18), the metering flow of the metering means (11) is monitored and, if necessary, regulated by a control unit (14).

14. The method as claimed in claim 10, wherein a plurality of the sensors (18) of a sensor network, each of which is assigned to a metering means (11), are evaluated in parallel and the measured values are compared with each other by the control unit (14).

15. The method as claimed in claim 10, wherein the acquired sensor signals are processed by an artificial neural network (ANN) in order to detect the type of collision on the basis of the acquired sensor signals, wherein the ANN is trained in particular using the acquired sensor signals, in order to predict and detect various collisions and to initiate appropriate counter-measures.
